(19) United States
(12) Patent Application Publication
(10) Pub. No.: US 2003/0048406 A1
(43) Pub. Date: Mar. 13, 2003

(54) Ultraviolet light filtration system, method, and device

(76) Inventor: Patricia A. Morrison, Sanger, TX (US)

Correspondence Address: Michael L. Diaz, Suite 200, 555 Republic Drive, Plano, TX, 75074, US

(21) Appl. No.: 10/234,999

(22) Filed: Sep. 4, 2002

Related U.S. Application Data
(60) Provisional application No. 60/322,496, filed on Sep. 12, 2001.

(51) Int. Cl. G02C 7/10

(52) U.S. Cl. 351/44

(57) ABSTRACT

An ultraviolet (UV) light filtration system, method and device for converting a pair of standard eyeglasses to a pair of sunglasses. A sheet of static cling vinyl is treated to impart UV-absorbent characteristics to the sheet. The sheet is preferably cut by a computerized cutting machine to the size and shape of the eyeglass lenses. Alternatively, the sheet may be molded in an injection mold to the desired size and shape. The vinyl sheet has a thickness that permits a static electricity charge on a surface of the sheet to hold the sheet on the eyeglass lenses.

### PRIORITY STATEMENT UNDER 35 U.S.C. § 119(e) & 37 C.F.R. § 1.78

This nonprovisional application claims priority based upon the prior U.S. provisional patent application entitled, “Ultraviolet Light Filtration Device for Eyeglasses” application No. 60/322,496, filed Sep.12, 2001 in the name of Patricia A. Morrison.

### BACKGROUND OF THE INVENTION

1. Technical Field of the Invention

This invention relates to sunglasses. More particularly, and not by way of limitation, the present invention is directed to an ultraviolet light filtration system, method, and device for use in converting standard eyeglasses to sunglasses.

2. Description of Related Art

A common problem experienced by people who wear eyeglasses with prescription corrective lenses is how to protect their eyes when they go outdoors in bright sunlight. Historically, such people have had three options to protect their eyes. First, they have carried a separate pair of prescription sunglasses. This option is expensive and requires that the person carry both pairs of eyeglasses if they are moving from indoors to outdoors. Second, they can purchase self-adjusting corrective lenses that adjust in shading according to the intensity of the incident light. This option is also expensive and provides the user with no control over the degree or color of shading. The third option is to purchase a pair of “clip-on” sunglasses that clip on or otherwise attach to the user's regular eyeglasses. This option may not be particularly attractive or socially acceptable, especially when “flipped up” above the user's regular eyeglasses. This option also requires that the user carry the separate clip-on sunglasses when not being used.

U.S. Pat. No. 6,113,233 to Miller attempts to solve the existing problems by using sunshading plastic film material to cover the eyeglass lenses. Static cling vinyl such as polyvinyl chloride (PVC) is known and is produced and sold by many manufacturers both domestic and foreign. It is commonly calendared into sheets of varying thicknesses. Naturally transparent, it can be treated with a variety of light filtration treatments, degrees of shading, or different colors. The sheets are often used to add tinting to windows for homes or automobiles. Miller discloses a process of aligning a sheet of such material with the lenses of a pair of eyeglasses, and using a pin to punch a series of holes in the film around the perimeter of the lenses. Scissors are then used to cut the film to form a lens cover for each lens. The lens covers are then applied to the lenses for use.

Miller's system has several disadvantages. One of the disadvantages is that the user must take a pin and poke a plurality of holes through the film toward the expensive prescription lenses of his eyeglasses. This may result in scratching the lenses. Another problem is that the user must accomplish this task with his or her vision-correcting eyeglasses removed. The wearer at that time may not be able to see well enough to poke holes in the right places. Additionally, the user must then be able to cut a smooth curve with the scissors, connecting the series of holes punched in the film. This would more than likely result in jagged and poorly fitting lens covers. Of course, Miller's system also requires that the user have a pair of scissors available to cut out the lens cover once the holes are made, and scissors may not always be available.

In order to overcome the disadvantage of existing solutions, it would be advantageous to have an ultraviolet light filtration system, method, and device for use in converting standard eyeglasses to sunglasses that overcomes the disadvantages of Miller and the other existing problems. The present invention provides such a system, method, and device.

### SUMMARY OF THE INVENTION

In one aspect, the present invention is directed to an ultraviolet (UV) light filtration device for converting a pair of standard eyeglasses to a pair of sunglasses. A sheet of transparent material is cut by a cutting machine to the size and shape of the eyeglass lenses. The sheet has a thickness that permits a static electricity charge on a surface of the sheet to hold the sheet on the eyeglass lenses. A UV-absorbent coating is applied to the sheet to provide UV light protection up to 99 percent or more.

In another aspect, the present invention is directed to a UV light filtration system. The system includes a pair of standard eyeglasses having two lenses of a predetermined size and shape, and a sheet of transparent UV-absorbent material cut by a cutting machine to the size and shape of the eyeglass lenses. The sheet has a thickness that permits a static electricity charge on a surface of the sheet to hold the sheet on the eyeglass lenses.

In yet another aspect, the present invention is directed to a method of filtering UV light from a user's eyes. The method includes storing an outline of at least one lens of a pair of eyeglasses worn by the user in a computer memory associated with a computerized cutting machine, and treating a sheet of static cling film to impart desired UV light filtering characteristics to the film. The method also includes cutting the sheet of static cling film with the computerized cutting machine to match the stored outline, and applying the cut static cling film to the lens of the eyeglasses to form a UV filtration system.

In still yet another aspect, the present invention is directed to a method of filtering UV light from a user's eyes that includes the steps of creating an injection mold in an outline matching an outline of at least one lens of a pair of eyeglasses worn by the user, and injecting liquified vinyl into the mold. This is followed by curing the vinyl in the mold to form a sheet of static cling vinyl shaped to cover the eyeglass lens, treating the sheet of static cling vinyl to impart desired UV light filtering characteristics to the sheet, and applying the molded and treated static cling sheet to the lens of the eyeglasses to form a UV filtration system.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a perspective view of a pair of eyeglasses illustrating a prior art method of cutting out lens covers from a sheet of sunshading film;

FIG. 2 is a flow chart illustrating the steps of two embodiments of the inventive method of filtering ultraviolet light;

FIGS. 3A-3C are plan views of various embodiments of the ultraviolet filtering device of the present invention; and

FIG. 4 is a perspective view of a pair of eyeglasses on which a one-piece filtering device is utilized to form the ultraviolet filtering system of the present invention.

### DETAILED DESCRIPTION OF EMBODIMENTS

The device of the present invention provides ultraviolet light filtration, glare control, and/or shading for prescription or corrective eyeglass wearers. The device may be manufactured from static cling PVC film which is cut or injection molded in the shape of eyeglass lenses. The device is placed directly on the lenses of the prescription or corrective eyeglasses, where it is held in place by a static electricity charge on the surface of the film, providing from 0 to 99 percent ultraviolet light filtration, glare control, and or shading without the loss of vision correction provided by prescription eyeglasses.

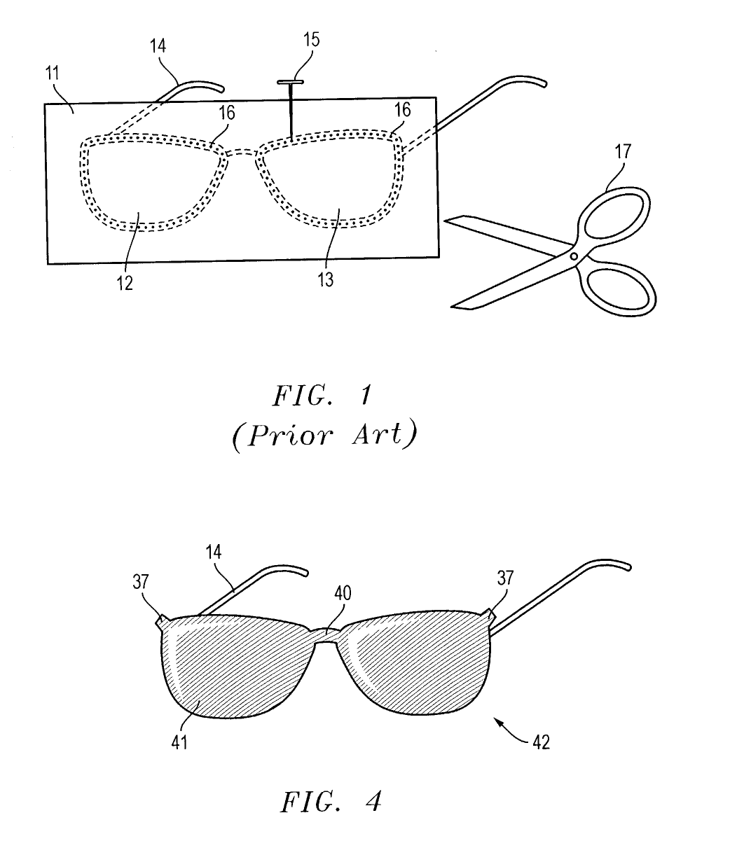

FIG. 1 is a perspective view of a pair of eyeglasses illustrating the prior art method of cutting out lens covers from a sheet of sunshading film, as disclosed in U.S. Pat. No. 6,133,233 to Miller. Miller discloses a process of aligning a sheet of sunshading film 11 with the lenses 12 and 13 of a pair of eyeglasses 14. A pin 15 is utilized to punch a plurality of holes 16 in the film around the perimeter of the lenses. Scissors 17 are then used to cut the film to form a lens cover for each lens. The lens covers are then applied to the lenses for use.

As noted above, Miller's system has several disadvantages. First, the user must take the pin 15 and punch the plurality of holes 16 through the film 11 toward the expensive prescription lenses 12 and 13 of his eyeglasses. This may result in scratching the lenses. Second, the user must remove his or her vision-correcting glasses to accomplish the task, and may not be able to see well enough to poke the holes in the right places. Third, the user may not be able to cut a smooth curve with the scissors 17, and this would result in jagged and poorly fitting lens covers. Finally, Miller's system also requires that the user have a pair of scissors available to cut out the lens cover once the holes are made, and scissors may not always be available.

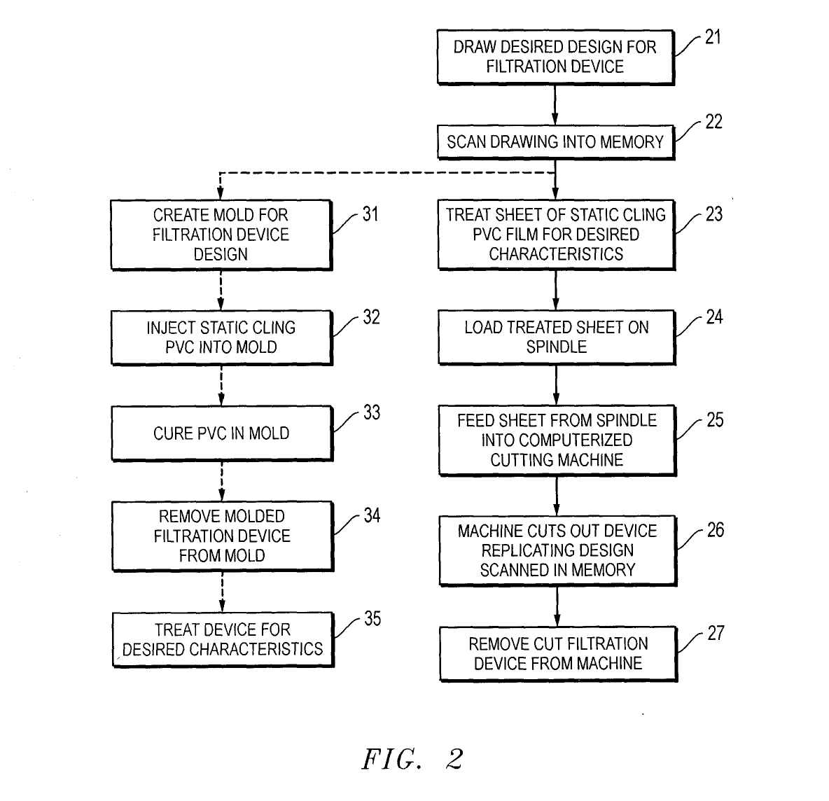

FIG. 2 is a flow chart illustrating the steps of two embodiments of the inventive method filtering ultraviolet light. At step 21, a desired design (i.e., shape and size) of the ultraviolet filtering device is drawn on a substrate in a contrasting color. For example, the design may be drawn with dark ink on a piece of white paper. The design may be determined by current style. At this time there are several basic shapes of lenses: Round, Horned Rimmed, Oval, and Aviator, but the invention is not limited to these styles. Because of the ease in changing the design, new shapes can be added or deleted depending upon current fashion.

At step 22, the design is scanned into a computer memory associated with a computerized cutting machine. At step 23, a sheet or roll of Static Cling PVC film may be treated with appropriate coatings to achieve an end-use film with desired characteristics. For example, the PVC film may be treated with coatings that provide the transparent film with a design that can only be seen from one side. The film may also be treated with glare control compounds, and may be polarized. The film has a thickness (for example, 1/16th inch or less) that permits the static electricity charge on the surface of the film to hold the film on the eyeglass lenses. Suitable manufacturers and importers of treated PVC sheets include GILA (www.gilafilms.com); Molco, Inc. (R.R. 2, Box 2372, Waymart, Pa. 18472); and Transilwrap Co., Inc. (9201 W. Belmont Ave., Franklin Park, Ill. 60131.

At step 24, the PVC film sheet is loaded onto a spindle, and at step 25 the sheet is fed into the computerized cutting machine. The cutting machine is controlled by a computer program that causes the cutting machine to cut the PVC sheet at step 26 in a design replicating the scanned design. The cutting may be accomplished by various methods including, but not limited to, cutting by a drag knife cutter, die cutting, stamping, laser cutting, sand blasting, or tangentially cutting. Each method produces a smooth, clean cut on the PVC film. Computerized cutting machines of this type are produced for the sign-making industry and can be purchased either domestically or imported from a number of sources. Suitable computerized cutting machines are available from Summa (25 Chestnut Street, Saugus, Mass. 01906); or Gerber Technology, Inc. (21 Lime Street, Marblehead, Mass. 01945). At step 27, the cut filtration device is removed from the cutting machine, and is ready to apply to a pair of eyeglasses.

In an alternative embodiment of the present invention, the static cling PVC may be molded into the various lens designs by injecting liquified vinyl such as PVC into an engineered mold. In this alternative embodiment, the method may proceed from step 22 to step 31 where an injection mold is created for the desired filtration device design. Injection molding firms capable of engineering the molds and performing injection work with the required tolerances include Tri-Cities Manufacturing, Inc. (Tuscumbia, Ala.); Flambeau (Baraboo, Wis.); and L A Packaging (Yorba Linda, Calif.). At step 32, the liquified PVC is injected into the mold where it is allowed to cure at step 33. At step 34, the molded filtration device is removed from the injection mold as a sheet of Static Cling PVC. Finally, at step 35, the molded sheet may be treated with appropriate coatings to achieve an end-use film with desired characteristics. The film is then ready to apply to a pair of eyeglasses. Although this embodiment is more costly than the first embodiment, it enables the maker to form raised edging or use filtration devices that are in excess of 1/16-inch thick.

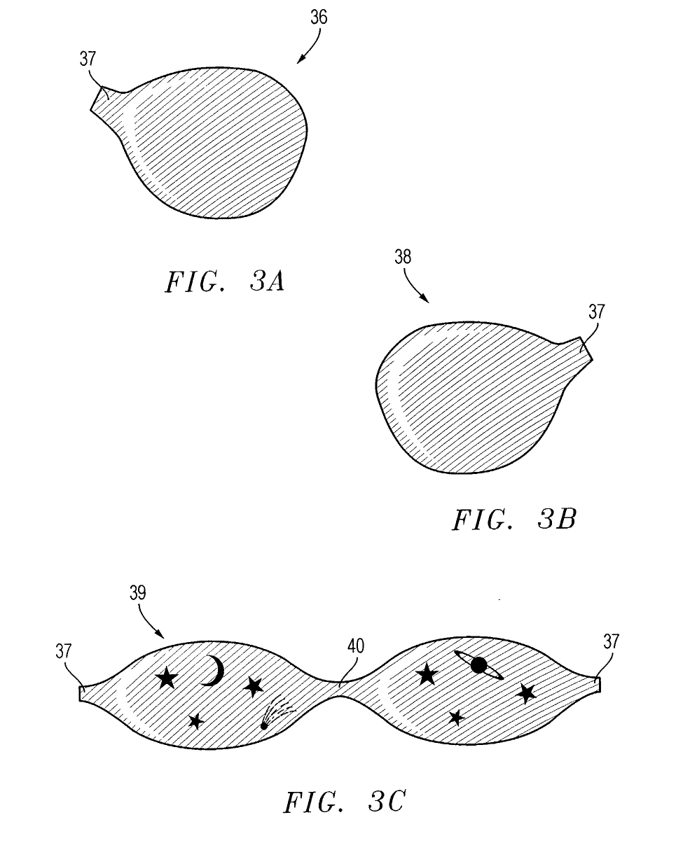

FIGS. 3A-3C are plan views of various embodiments of the ultraviolet filtering device of the present invention. The devices are packaged pre-cut to the size and shape of standard eyeglasses. In FIGS. 3A and 3B, the filtration device is cut into two separate but identical lens shapes (one for each lens of the eyeglasses). Only one of the halves is shown in each figure. In FIG. 3A, a Round shape 36 is shown. The design is also shown to include an optional handling tab 37. The handling tab is a slight extension of the lens shape which may be utilized by the user to remove the lens-shaped filtration device from its package, and to apply or remove the filtration device from the eyeglass lens without smudging the device or the prescription lens. The tab may be positioned, for example, at the juncture of the earpiece and the eyeglass frame. To apply the filtration device, the user merely holds the filtration device by the removal tab and gently touches the device to the lens of the prescription eyeglasses. The static cling properties of the film causes the filtration device to instantly and securely cling to the prescription lenses. To remove the filtration device, the user gently pulls on the removal tab and peels the film off of the eyeglass lenses. If the filtration device has separate pieces for each lens, the two pieces can be stuck together and stored in a shirt pocket, envelope, wallet or any other convenient place. If the filtration device becomes soiled, it can be rinsed off with plain water and reused.

In FIG. 3B, a Horn Rimmed shape 38 is shown, also with the handling tab 37. In FIG. 3C, an Oval shape 39 is shown in an embodiment in which the filtration device is cut or molded as a single piece. The optional handling tab 37 may be formed on each side of the device. A narrow band 40 crosses the bridge of the user's nose and connects the two lens shapes. As illustrated in FIG. 3C, the PVC film has been treated with a coating that provides the transparent film with a design that can only be seen from one side.

FIG. 4 is a perspective view of a pair of eyeglasses 14 on which a one-piece filtering device 41 is utilized to form the ultraviolet filtering system 42 of the present invention. Once the filtration device is placed on the eyeglass lenses, the user has glare control and ultraviolet light protection up to 99% or better. Depending on the coatings applied to the PVC film, the user can fashionably control the color and shading of the eyeglass lenses. The user is still able to read street signs or maps and the like, and still has the same amount of vision correction he or she had before applying the filtration device.

The present invention offers many advantages over prior art devices and methods. Because the device is cut by a computerized cutting machine, the shape is uniform and has no wavy or irregular edges. Additionally, because the device attaches to the lenses with static electricity, the shape and size does not have to be exactly the size and shape of the prescription lens. Also, the device is easily removed and exchanged for a device of a different shape, color, or shade, thereby enabling the user to enjoy ultraviolet light protection in a variety of styles and colors at a cost much less than purchasing multiple pairs of prescription sunglasses. Additionally, the manufactured filtration device is lightweight, adding virtually no additional pressure on the nose or bridge area of the user. Therefore, the device does not encourage the eyeglasses to slip down on the user's nose because of additional weight, like the “clip on” styles do.

It is thus believed that the operation and construction of the present invention will be apparent from the foregoing description. While the system, method, and device shown and described has been characterized as being preferred, it will be readily apparent that various changes and modifications could be made therein without departing from the scope of the invention as defined in the following claims.

What is claimed is:

1. An ultraviolet (UV) light filtration system comprising:
a pair of standard eyeglasses having two lenses of a predetermined size and shape; and
a sheet of transparent UV-absorbent material cut by a cutting machine to the size and shape of the eyeglass lenses, said sheet having a thickness that permits a static electricity charge on a surface of the sheet to hold the sheet on the eyeglass lenses.

2. The UV light filtration system of claim 1 wherein the sheet includes a handling tab that extends beyond an edge of at least one of the eyeglass lenses.

3. The UV light filtration system of claim 1 wherein the sheet is treated with a glare control compound.

4. The UV light filtration system of claim 1 wherein the sheet is treated with a coating that provides the transparent film with a design that can only be seen from one side.

5. The UV light filtration system of claim 1 wherein the sheet is cut into a design selected from the group consisting of:
Round;
Horned Rimmed;
Oval; and
Aviator.

6. The UV light filtration system of claim 1 wherein the sheet is cut as a single piece comprising:
a first portion covering a first eyeglass lens;
a second portion covering a second eyeglass lens; and
a narrow band connecting the first and second portions.

7. The UV light filtration system of claim 1 wherein the sheet is cut as two separate pieces, each piece covering a different one of the eyeglass lenses.

8. An ultraviolet (UV) light filtration device for converting a pair of standard eyeglasses to a pair of sunglasses, said standard eyeglasses having two lenses of a predetermined size and shape, said filtration device comprising:
a sheet of transparent material cut by a cutting machine to the size and shape of the eyeglass lenses, said sheet having a thickness that permits a static electricity charge on a surface of the sheet to hold the sheet on the eyeglass lenses; and
a UV-absorbent coating on said sheet.

9. The UV light filtration device of claim 8 wherein the sheet is made of static cling vinyl.

10. The UV light filtration device of claim 9 wherein the static cling vinyl is polyvinyl chloride (PVC).

11. The UV light filtration device of claim 8 wherein the UV-absorbent coating includes a glare control compound.

12. The UV light filtration device of claim 8 wherein the UV-absorbent coating is polarized.

13. The UV light filtration device of claim 8 wherein the sheet includes a handling tab that extends beyond an edge of at least one of the eyeglass lenses.

14. The UV light filtration device of claim 8 wherein the sheet is cut as a single piece comprising:
a first portion covering a first eyeglass lens;
a second portion covering a second eyeglass lens; and
a narrow band connecting the first and second portions.

15. A method of filtering ultraviolet (UV) light from a user's eyes comprising the steps of:
storing in a computer memory associated with a computerized cutting machine, an outline of at least one lens of a pair of eyeglasses worn by the user;
treating a sheet of static cling film to impart to the film, desired UV light filtering characteristics;
cutting the sheet of static cling film with the computerized cutting machine to match the stored outline; and
applying the cut static cling film to the lens of the eyeglasses to form a UV filtration system.

16. The method of filtering UV light of claim 15 wherein the step of storing the outline in memory includes storing an outline of at least one lens of the user's eyeglasses with an extension tab operable to enable the user to apply the cut static cling film to the lens without smudging the film or the lens.

17. The method of filtering UV light of claim 15 wherein the step of storing the outline in memory includes the steps of:
drawing the outline on a substrate in a shade that contrasts with the shade of the substrate; and
scanning the drawn outline into the computer memory.

18. The method of filtering UV light of claim 15 wherein the step of cutting the sheet of static cling film with the computerized cutting machine includes cutting a single piece of film comprising a first portion shaped to cover a first eyeglass lens, a second portion shaped to cover a second eyeglass lens, and a narrow band connecting the first and second portions.

19. A method of filtering ultraviolet (UV) light from a user's eyes comprising the steps of:
creating an injection mold in an outline matching an outline of at least one lens of a pair of eyeglasses worn by the user;
injecting liquified vinyl into the mold;
curing the vinyl in the mold to form a sheet of static cling vinyl shaped to cover the eyeglass lens;
treating the sheet of static cling vinyl to impart to the sheet, desired UV light filtering characteristics; and
applying the molded and treated static cling sheet to the lens of the eyeglasses to form a UV filtration system.

20. The method of filtering UV light of claim 19 wherein the step of creating an injection mold in an outline matching an outline of at least one lens of a pair of eyeglasses includes creating an injection mold that forms a raised edging around a perimeter of the outline.
